(19) United States
(12) Patent Application Publication
(10) Pub. No.: US 2016/0220032 A1
(43) Pub. Date: Aug. 4, 2016

(54) Process For Producing Foam Mattresses With Embedded Spring And Mattress Produced By This Method

(71) Applicant: Sebastian LABANOWICZ, Olesnica (PL)

(72) Inventor: Sebastian LABANOWICZ, Olesnica (PL)

(21) Appl. No.: 15/021,273

(22) PCT Filed: Sep. 16, 2014
(86) PCT No.: PCT/PL2014/050056

§ 371 Date: Mar. 11, 2016

(30) Foreign Application Priority Data
Sep. 16, 2013 (PL) 405349

(51) Int. Cl. A47C 27/06; B68G 11/06

(52) U.S. Cl. CPC A47C 27/063; B68G 11/06

(57) ABSTRACT

The object of the invention is the method of making innerspring foam mattresses, wherein the spring cores (3) of the mattresses are placed on a belt conveyor and covered with the external foam panel (2), after which paper-and-foil medium (4) is placed on a belt conveyor under spring cores (3), and then the space between the external foam panel (2) and the paper-and-foil medium (4), comprising the spring core (3), is filled with liquid foam material through a pouring trough (5) situated below the spring cores (3) traveling above it, a flattening mat (7) is placed upon the upper surface of the external foam panel (2) in order to limit the foam expansion, and to reach the desired mattress thickness, and then the resulting slab is cut by means of an automatic cutting knife (6) into mattresses of desired geometrical dimensions. The second object of the invention is the mattress produced with the method of the first object of the invention. The object of the invention is also the mattress with the spring core (3) filled with foam which tightly surrounds the spring core (3) springs.

The object of the present invention is the method of making innerspring foam mattresses applicable to furniture industry, an innerspring mattress obtained with the said method, and an innerspring mattress.

The method of making innerspring mattresses is known for U.S. Pat. No. 3,099,518. In the solution referred to above, the springs, after having been coated with a plastic film forming an envelope enclosing each spring, are placed on a belt conveyor. The lower strip of the external foam layer is moving along a belt conveyor, upon which the springs are placed, and then the polyurethane foam is poured over the whole structure. The foam expands up to the height limited with the upper external foam strip provided at an appropriate distance from the foam dispenser. In the solution quoted above, the poured foam fills the gaps between the springs enclosed in film envelopes, whereby the inside of the envelopes remains empty. For obtaining harder mattresses, thicker foams are required, characterized with high self-weight, or springs made of thicker wire, which also increases the weight of the product and results in increased raw materials (spring wire) consumption. Additionally, the method according to the invention referred to requires an additional technological process, i.e. covering the springs with plastic film forming the pockets. Due to relatively high difficulty of coating (e.g. by spraying) the springs with plastic, this step requires additional activities verifying the quality and reliability of the process. Furthermore, the polyurethane foam is dispensed from a hopper from the top, which may result in crack formation, uneven filling, air gaps between spring pockets, flooding the upper part of a spring pocket, and by the same uneven foam density and hardness.

American document No. U.S. Pat. No. 4,492,664, on the other hand, provides a method for continuous plastic foaming process, particularly polyurethane, in a classical continuous production system using a belt conveyor upon which polyurethane foam is poured from a dispensing head. In order to limit the foam expansion, layers of paper combined with plastic were used that were placed on the sides and above the belt. The layer of plastic binds with the foam and is a lost form, while the paper can be reused. The solution referred to above does not provide for production of mattresses with embedded springs and the presented method does not allow to make such type of products. Furthermore, the foam is poured by means of a dispensing head from above, which results in crack formation, uneven filling, or air pockets due to uneven expansion of the foam.

It should be also noted that the mattress market requires, for ecological reasons, products which limit to the highest possible degree the emission of CO₂, consumption of power, fuels and hazardous chemical compounds like adhesives or solvents, in the production process. Furthermore, there is a risk of fire during manufacturing mattresses, particularly bonnell ones, due to sparking from the spring coils in contact with adhesives and solvents used for gluing the external foam panels.

The technological problem that the present invention is facing is to provide such method of making innerspring foam mattress, which will be easy to implement in the existing polyurethane foam production lines, will allow for making innerspring mattresses in a continuous or discontinuous process, will not require complicated operations of covering the springs with plastic film, will eliminate the problem of crack formation. uneven filling, air pockets between the springs, uneven foam density and hardness, will eliminate the use of adhesives or other substances bonding two layers of foam (the external layer with the mattress core), will reduce the consumption of spring raw material, will allow to use less dense foams which will reduce the product weight and will favorably influence transport costs, and will allow to use polyurethane foams made from renewable products, and will reduce the fire hazard during production of mattresses, wherein the finished product will be free from the squeaking effect, and will be resistant to damages resulting from lateral displacement of the springs cause by angular load. Unexpectedly, the technical problems mentioned above have been solved by the present invention.

The first object of the invention is the method of making innerspring foam mattresses, characterized in that it comprises the following steps:

a) spring mattress cores are prepared and preferably placed on a conveyor, preferably a belt conveyor,

b) the cores of step a) are covered with at least one external foam panel,

c) a bearing material, preferably paper-and-foil medium, is placed on the conveyor below the spring cores,

d) the space between the external foam layer and the medium, comprising the spring core, is filled with liquid foam material,

e) a flattening mat is placed upon the upper surface of at least one external foam panel in order to limit the foam expansion and reach the desired mattress thickness.

Preferably, pouring of foam in step d) takes place through a pouring trough situated below the spring cores traveling above it. In a preferred embodiment, the method of making the mattresses is carried out in a continuous process. In another preferred embodiment, the spring cores are serially connected with one another with a thin cotton or synthetic band forming a gaps between them. Preferably, after step e) the resulting slab is cut into desired size mattresses with an automatic knife cutting along the gaps between the spring cores. Equally preferably, the poured foam material was obtained on the basis of renewable products. In another preferred embodiment, the foam filling and flooding the spring cores is of low density ranging from 19 kg/m³ to 30 kg/m³. In another preferred embodiment, the external foam panel is made from renewable raw materials.

The second object of the present invention is the innerspring foam mattress, characterized in that it has been made according to the method defined in the first object of the invention.

The third object of the present invention is the innerspring foam mattress, characterized in that the free space in the spring core is completely filled with foam tightly enclosing the springs forming the spring core. Preferably, the innerspring foam mattress comprises an external foam panel on the top surface of the spring core filled with foam. Equally preferably, the foam filling and flooding the spring cores is of low density ranging from 19 kg/m³ to 30 kg/m³. In another preferred embodiment, the external foam panel is made of foam from renewable raw materials.

The method of making innerspring mattresses of the present invention is easy to implement in the existing polyurethane foam production lines due to its simple structure and the possibility to use a major portion of the production line without the need for its modification. It can be run in a continuous way, increasing the amount of the manufactured product. Due to filling the spaces between the springs in the spring core of the mattress with foam, there is no need to close them beforehand, and it also allows using springs made of smaller diameter wire and/or foams of lower densities to obtain the same hardness as in classical mattresses, reducing, therefore, their self-weight, which is preferred in terms of transportation and storage. Implementation of the method of the invention promotes environmental performance of the process by eliminating the requirement for adhesives and solvents to bind the external foam panel with the foam filled spring core. Furthermore, elimination of adhesives and solvents reduces fire hazard during production. The production process itself becomes simplified, too, since the obtained foams need not to be cut into pieces and bind together.

The mattress of present invention, due to the application of complete filling the spring core with foam, enables using a spring core made of smaller diameter wire. Such structure also eliminates the squeaking effect present in bonnell mattresses. Additionally, the filling foam may have lower density due to the used spring structure of the mattress. Due to the above factors, the mattress, retaining all usable features, produced that way is characterized with lower weight than classic mattresses of known structure, which preferably influences the reduction of transportation or storage costs. Filling the gaps between the springs with polyurethane foam reduces the risk of damage to the mattress due to lateral displacement of springs caused by angular load.

Exemplary embodiments of the invention have been presented in the drawings, wherein

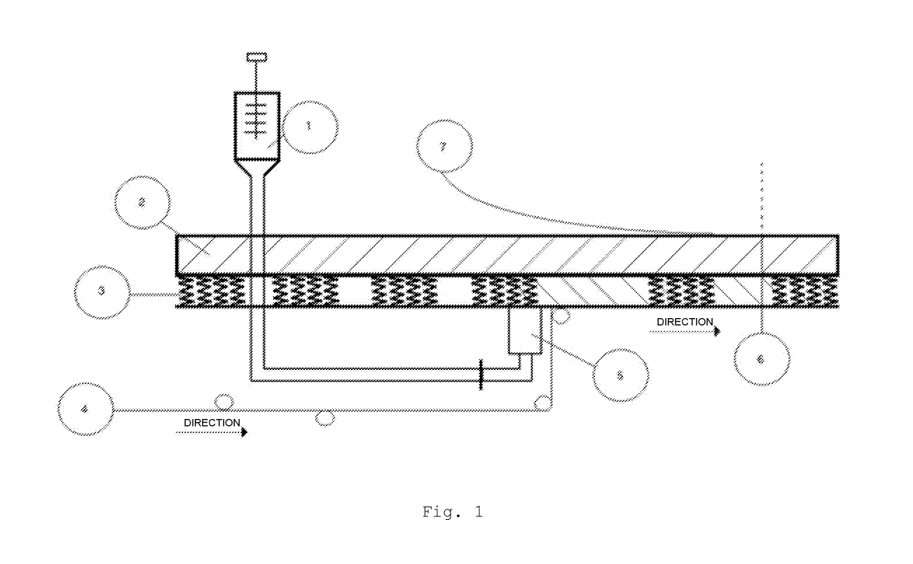

FIG. 1. is a schematic view of the production line for making innerspring mattresses,

FIG. 2 is a perspective view of the mattress made with the method according to the invention,

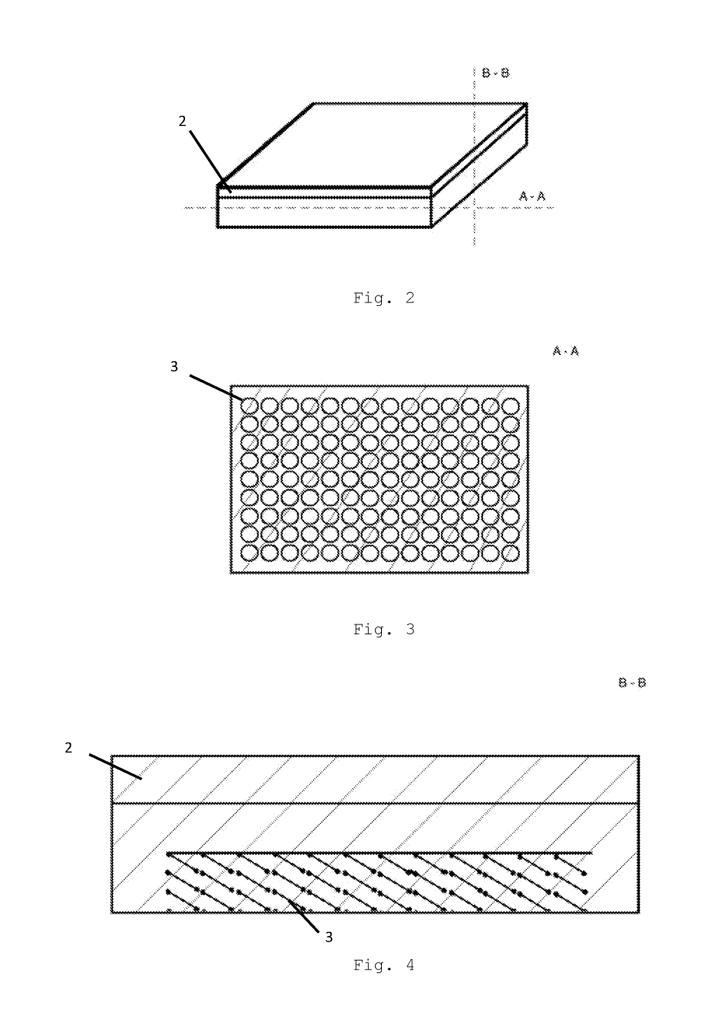

FIG. 3 is a top view of the mattress cross-section along A-A line, and

FIG. 4 is a side view of the mattress cross-section along B-B line,

### EXAMPLE 1

FIG. 1. represents a schematic view of the production line for making innerspring mattresses. Mattress spring cores 3 linked serially with one another with cotton or synthetic material bands are placed upon a belt conveyor so that there are empty spaces between cores 3 sufficient for cutting the finished slab into individual products. Spring cores 3 of Bonnell type mattresses were made of wire with 1.8 mm in diameter and had different hardness zones. Serially connected spring cores 3 moving on the conveyor belt were covered with the external foam panel 2 made of polyurethane foam obtained from renewable products, e.g. polyols from rapeseed oil. A paper-and-foil medium 4 unwound from a bale has been placed on a belt conveyor under spring cores 3. The pouring chute 5 for the foam product was situated below traveling spring cores 3 just before the point of application of the foil-and-paper medium 4. The foam material mixture was dispensed by agitator 1 to the pouring chute 5. This way, the foam material was poured into the space surrounding the spring cores 3, created between the external foam panel 2 and the paper-and-foil medium 4. Traveling along the belt conveyor, the foam material got foamed and expanded, reaching the density of 19 kg/m³. In order to obtain the desired mattress thickness, a flattening mat 7 was used, placed upon the upper surface of the external foam panel 2, which pressed the mattress layers together and prevented further foam expansion. Pouring the foam material between the external foam panel 2 layer and the paper-and-foil medium 4 resulted in spontaneous bonding the external foam panel layer 2 with the foam filling and surrounding the spring core 3 of the mattress. The foil of the paper-and-foil medium 4 adhered to the lower surface of the mattress in a lost form fashion, while the paper, wound on a drum, could be reused. After the foam material having set on the belt conveyor, cutting the long mattress slab with the automatic cutting knife 6 took place, finally forming the mattresses obtained with the method.

The method of making innerspring foam mattresses did not require application of hazardous chemical substances to bind the external foam panel layer 2 and the spring core 3 filled with foam, i.e. adhesives and solvents. Due to filling the whole space between the spring core 3, it was possible to use lower density foam, obtaining appropriate hardness of individual zones, and spring cores 3 made of smaller diameter wire, reducing by the same the self-weight of the manufactured product, which in turn translates into lower transportation and storage costs.

### EXAMPLE 2

The innerspring foam mattress was obtained with the method of example 1. A mattress was obtained, which was characterized with lower self-weight as compared to a foam mattress manufactured with a traditional method, and to the pocket mattress (due to smaller amount of the wire used for spring cores 3), retaining the same usability features, such as hardness, controlled zones, and thickness. The effect was reached by filling the mattress spring cores 3 mad of smaller diameter wire and lower density foam. Filling the whole spring cores 3 space increased the resilience of the springs themselves, which made it possible to apply lighter foam of lower density and smaller diameter wires.

### Example 3

The innerspring foam mattress comprised a spring core 3 made of wire with 1.8 mm diameter. The spring core 3 was completely filled with polyurethane foam with the density of 19 kg/m³. The upper surface of the core 3 was covered with the external foam panel 2 made of foam materials based on renewable raw materials, i.e. rapeseed polyols. Bonding the external foam panel 2 with the mattress core 3 was provided without the use of adhesive and took place during production. The weight of such mattress was lower as compared to the weight of a classical foam mattress and a pocket mattress of the same usability features (geometrical dimensions, hardness, flexibility, number and hardness of zones, etc.). Thus, the product transport and storage costs have been reduced.

1. The method of making innerspring foam mattresses, characterized in that it comprises the following steps:
a) mattress spring cores are prepared or placed on a conveyor,
b) the cores of step a) are covered with at least one external foam panel,
c) a bearing material is placed on the conveyor below the spring cores,
d) the space between the external foam panel and the medium, comprising the spring core, is filled with liquid foam material,
e) a flattening mat is placed upon the upper surface of at least one external foam panel in order to limit the foam expansion, and to reach the desired mattress thickness.

2. The method of making innerspring foam mattresses of claim 1, characterized in that pouring of foam in step d) takes place through a pouring trough situated below the spring cores traveling above it.

3. The method of making innerspring foam mattresses of claim 1, characterized in that it is run in a continuous process.

4. The method of making innerspring foam mattresses of claim 1, characterized in that the spring cores are serially connected with one another with a thin cotton or synthetic band forming a gaps between them.

5. The method of making innerspring foam mattresses of claim 1, characterized in that after step e) the resulting slab is cut into mattresses of desired dimensions using a cutting knife along the gaps between the spring cores.

6. The method of making innerspring foam mattresses of claim 1, characterized in that the poured foam material was obtained on the basis of renewable raw materials.

7. The method of making innerspring foam mattresses of claim 1, characterized in that the foam filling and flooding the spring cores is of low density ranging from 19 kg/m³ to 30 kg/m³.

8. The method of making innerspring foam mattresses of claim 1, characterized in that the external foam panel is made of foam based on renewable raw materials.

9. The innerspring foam mattress, characterized in that it was obtained by means of the method defined in claim 1.

10. The innerspring foam mattress, characterized in that the free space in the spring core is completely filled with foam tightly enclosing the springs forming the spring core.

11. The innerspring foam mattress of claim 10, characterized in that it comprises the external foam panel on the upper surface of the spring core filled with foam.

12. The innerspring foam mattress of claim 10, characterized in that the foam filling and flooding the spring cores is of low density ranging from 19 kg/m³ to 30 kg/m³.

13. The innerspring foam mattress of claim 10, characterized in that the external foam panel is made of foam based on renewable raw materials.

14. The method of making the innerspring foam mattresses of claim 1, where in step a), the mattress spring cores are placed on the conveyer that is a belt conveyer.

15. The method of making the innerspring foam mattresses of claim 1, wherein the bearing material is a paper-and-foil medium.

16. The method of making the innerspring foam mattresses of claim 5, wherein said cutting knife is an automatic cutting knife.
